(19) United States
(12) Patent Application Publication
(10) Pub. No.: US 2018/0103656 A1
(43) Pub. Date: Apr. 19, 2018

(54) FROZEN PRODUCT DISPENSING SYSTEMS AND METHODS

(71) Applicant: FBD PARTNERSHIP, LP, San Antonio, TX (US)

(72) Inventors: Carlos ACOSTA, San Antonio, TX (US); Michael Ryan LASCH, Schertz, TX (US); Gilbert SALAZAR, Universal City, TX (US); Joshua Gary WARD, San Antonio, TX (US)

(73) Assignee: FBD PARTNERSHIP, LP, San Antonio, TX (US)

(21) Appl. No.: 15/785,599

(22) Filed: Oct. 17, 2017

Related U.S. Application Data
(60) Provisional application No. 62/409,172, filed on Oct. 17, 2016.

(51) Int. Cl. A23G 9/22; A23G 9/28

(52) U.S. Cl. CPC A23G 9/222; A23G 9/28

(57) ABSTRACT

An improved frozen product dispenser wherein a product is placed into a cooled hopper and the product is then fed from the hopper into a freezing and dispensing chamber where it is frozen and dispensed.

### CROSS REFERENCE TO RELATED APPLICATIONS

This application claims priority to U.S. Provisional patent application Ser. No. 62/409,172, filed Oct. 17, 2016, the contents of which are incorporated by reference herein in their entirety.

### STATEMENT REGARDING FEDERALLY SPONSORED RESEARCH/DEVELOPMENT

Not applicable.

### REFERENCE TO APPENDIX

Not applicable.

### BACKGROUND OF THE INVENTION

The subject matter of this disclosure relates to improved frozen product dispenser systems and methods wherein a product is placed into a cooled hopper and the product is then fed from the hopper into a freezing and dispensing chamber where it is frozen and dispensed.

Frozen product dispensers, generally, have been known in the art and have been used to freeze and dispense a variety of products including, but not limited to food products such as beverages, ice cream, yogurt, and other food items. Such prior art dispensers have suffered from various shortcomings and/or limitations.

One of several objects of the teachings of this disclosure is to resolve or reduce the identified—and other—shortcomings and/or limitations in prior art frozen product dispensers.

### BRIEF SUMMARY OF SELECT ASPECTS OF THE INVENTION

None of these brief summaries of the aspects of the invention is intended to limit or otherwise affect the scope of the appended claims, and nothing stated in this Brief Summary of the Invention is intended as a definition of a claim term or phrase or as a disavowal or disclaimer of claim scope.

Applicants have created an improved frozen product dispenser wherein a product is placed into a cooled hopper and the product is then fed from the hopper into a freezing and dispensing chamber where it is frozen and dispensed.

In one form, Applicant's invention comprises a frozen food dispensing machine, comprising: a product chamber that defines a bottom having a drain opening passing therethrough, the drain opening being defined by a portion of the bottom having a thickness; a freezing barrel positioned substantially below the product chamber comprising a machined surface that defines a leveled portion in contact with a portion of the product chamber proximate to the drain opening, and a boss raised above the leveled surface, wherein the height of the boss is substantially equal to the thickness of the product chamber that defines the drain opening; and a weldment having no seam that provides a smooth surface between the product chamber and the freezing chamber.

Another form of Applicant's invention comprises a dual air tube mix tube assembly for a frozen food dispensing machine comprising: a base comprising an upper surface, a lower surface, the base defining first and second openings passing therethrough, wherein the base is designed to cooperate with a drain of a product chamber to create a seal between the base and the drain; a first air tube passing through the first opening in the base, wherein the first air tube has a first portion that ascends above the upper surface of the base and has a second portion that descends below the lower surface of the base; a product tube having an inner annulus aligned with the second opening such that product can flow through the second opening and into and through the product tube; wherein at least a portion of the product tube descending below the lower surface of the base; and a second air tube passing through the second opening, wherein the second air tube has a first portion that ascends above the upper surface of the base, and a second portion that is positioned within the product tube.

Another form of Applicant's invention comprises a mix tube controller for use with a frozen food dispensing machine including a mix tube assembly having a base with a product annulus passing therethrough and an air tube extending from the base, the mix tube controller comprising: a plate, the plate defining a central opening and first and second product openings passing therethrough, where the area of the first opening is different from the area of the second opening, the central opening of the plate being sized such that the air tube of the mix tube assembly can pass through the central opening such that the plate is positioned about the air tube; a handle coupled to the plate, the handle permitting rotation of the plate to at least a first and a second angular position with respect to the air tube when the plate is positioned about the air tube of a mix tube assembly; wherein rotation of the handle to the first angular position will cause the first opening in the plate to be substantially aligned with the product annulus and rotation of the handle to the second angular position will cause the second opening in the plate to be substantially aligned with the product annulus.

Yet another form of Applicant's invention comprises a separation plate for use with a frozen food dispensing machine that includes a drive shaft extending into a freezing barrel, the freezing having a generally circular cross-section defining a diameter, the separation plate comprising: a generally circular plate designed to be connected to the drive shaft of the food dispensing machine and within the freezing barrel wherein the distance between the outer edges of the separation plate and the inside of the freezing barrel are between 2% and 7% of the diameter of the freezing barrel.

The following examples are included to demonstrate preferred embodiments of the inventions. It should be appreciated by those of skill in the art that the techniques disclosed in the examples which follow represent techniques discovered by the inventors to function well in the practice of the inventions, and thus can be considered to constitute preferred modes for its practice. However, those of skill in the art should, in light of the present disclosure, appreciate that many changes can be made in the specific embodiments which are disclosed and still obtain a like or similar result without departing from the scope of the inventions.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIGS. 1A-1C illustrate at a high level an exemplary frozen product dispenser constructed in accordance with certain teachings set forth herein.

FIG. 2 illustrates certain details an exemplary frozen product dispenser in which the hopper is positioned above the mixing and freezing barrel in accordance with certain teachings set forth herein.

FIG. 3 illustrates an isometric cross-sectional view of an exemplary frozen product dispenser showing a single hopper, a freezing and mixing barrel, a separation plate, and a mixing tube in accordance with certain teachings set forth herein.

FIGS. 4A and 4B illustrate isometric cross-sectional views of the hopper and freezing barrel of an exemplary frozen product dispenser in accordance with certain teachings set forth herein.

FIGS. 5A and 5B illustrate cross-sectional views of an exemplary mix tube connected to a freezing barrel of an exemplary frozen product dispenser in accordance with certain teachings set forth herein.

FIG. 6 is a view of a separation plate within a freezing barrel of an exemplary frozen product dispenser in accordance with certain teachings set forth herein.

FIGS. 7A and 7B illustrate an exemplary mix tube assembly of an exemplary frozen product dispenser in accordance with certain teachings set forth herein.

FIG. 8 illustrates an exploded isometric view of an exemplary mix tube assembly and adjustable overrun control of an exemplary frozen product dispenser in accordance with certain teachings set forth herein.

FIG. 9 illustrates another view of the exemplary mix tube assembly and adjustable overrun control of an exemplary frozen product dispenser in accordance with certain teachings set forth herein.

FIG. 10 illustrates another view of the exemplary mix tube assembly with a detailed view of the top portion of the exemplary mix tube assembly in accordance with certain teachings set forth herein.

FIGS. 11A and 11B illustrate two views of an exemplary air cap in accordance with certain teachings set forth herein.

FIGS. 12A, 12B, and 12C illustrate three views of an alternative mix tube assembly in accordance with certain teachings set forth herein.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

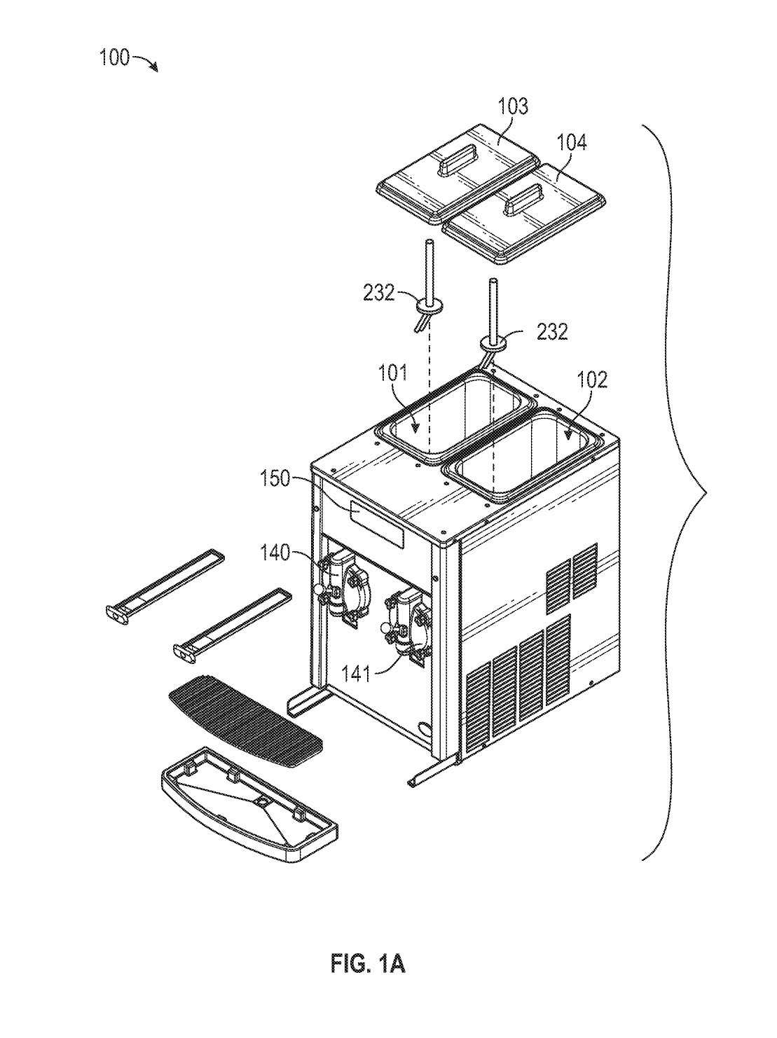

Turning to the drawings and, in particular, to FIGS. 1A, 1B, and 1C, aspects of an exemplary frozen product dispenser 100 are illustrated. For purposes of the following discussion, the product to be dispensed by the frozen product dispenser 100 will be described in the context of a dairy-based food product, such as a soft serve ice cream product, smoothies, milk shakes, or a frozen yogurt product. It should be understood, however that—unless explicitly so indicated—the teachings, disclosure and recitation of claimed subject matter set forth herein is not limited to food products generally, or to dairy-based food products specifically, and that the teachings and disclosed embodiments discussed herein may be beneficially used in connection with other food products and with non-food products.

Components and arrangements suitable for use as the main system structure 100 are illustrated, for example, in issued U.S. Pat. Nos. 6,536,224, 6,625,993, 8,528,786, 8,701,939, 8,875,732, and 9,388,033, and in Published Pending U.S. Patent Applications Nos. 20100293965 and 20160089702, the relevant disclosure of which are incorporated herein by reference in its entirety. For purposes of easy discussion, at a high level, the illustrated frozen product dispenser 100 may be considered as including four basic operational systems.

Initially, the illustrated frozen product dispenser 100 includes a product storage system that includes basins in the form of hoppers 101 and 102 that are designed to receive and store the product to be frozen and dispensed. Access to the hoppers 101 and 102 may be provided via removable lids 103 and 104, and product to be frozen and dispensed may be poured into the hoppers 101 and 102. As described in the illustrated exemplary system, the product storage system may include components to (i) quickly bring the product in the hoppers 101 and 102 to a desired temperature, (ii) to maintain the product in the hoppers at a desired temperature and (iii) to control the flow of heat into and from the contents of the hopper so as to subject the contents to various processes—such as a pasteurization process. In addition, the product storage system may include sensors and systems for detecting, directly and/or inferentially, the level of product in the hoppers 101 and 102 to alert the operator of the frozen product dispenser when the contents are low and/or in a condition wherein dispensing should be halted. The product storage system includes mix tube assemblies 232 to deliver the product from the hoppers 101, 102 to the freezing barrels 105, 106.

In addition to the product storage system, the illustrated frozen beverage dispenser further includes a product freezing system that includes one or more freezing barrels 105 and 106 that receive product from the hoppers 101 and 102 and freeze the product for subsequent dispensing. In the illustrated embodiment, the product freezing system also includes a rotating scraper or beater positioned inside the freezing barrels (not specifically illustrated in FIGS. 1A-1C) that are driven, in a controlled manner, by drive motors (one of which 120 is illustrated in FIGS. 1B and 1C). Additional details of the product freezing system are provided below.

The illustrated frozen product dispenser 100 further includes a refrigeration system that includes a compressor 130 and a condenser 132. In operation, the refrigeration system, provides compressed refrigerant at a high pressure to an evaporator within the product storage system and the product freezing system to cool the stored product and/or freeze the product in the freezing system, and receives vapor from the evaporator that is then compressed, passed through the condenser 132, and provided to the product and storage systems to repeat the refrigeration cycle.

Further, the illustrated frozen product dispenser includes a dispensing and interface system that includes dispensing valves 140 and 141 and a control and man-machine interface 150. The dispensing valves 140 and 141 may be actuated to dispense frozen product from the freezing barrels and/or locked out to prevent the dispensing of product. The man-machine interface 150 may be used to permit configuration of the frozen product dispenser 100 and/or the input of data that can be used to control the operation of the dispenser. It can also be used to provide notices and information from the dispenser to the operator of the frozen product dispenser.

It will be appreciated that the four systems described above are not necessarily isolated from each other and that the placement of a specific physical component within one system is, to some extent, arbitrary. For example, the evaporator used to cool the contents of the hoppers 101 and 102 could almost equally be considered part of the product storage system or the refrigeration system. The references to the various systems contained herein should therefore, not be considered physical aspects of the described frozen product dispenser 100, but rather concepts useful in describing various aspects of the structure and operation of the exemplary systems, methods and apparatus discussed herein.

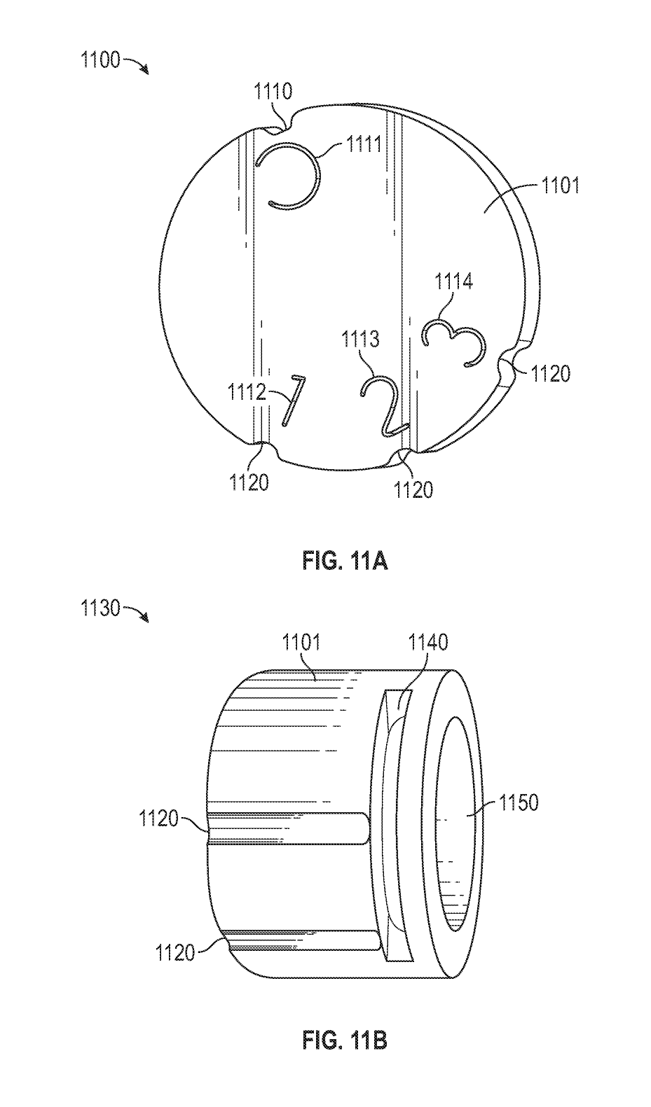

As reflected most specifically in FIG. 10 the frozen product dispenser also includes various support and shrouding elements that are not specifically numbered or discussed but will be understood to form part of the dispenser structure.

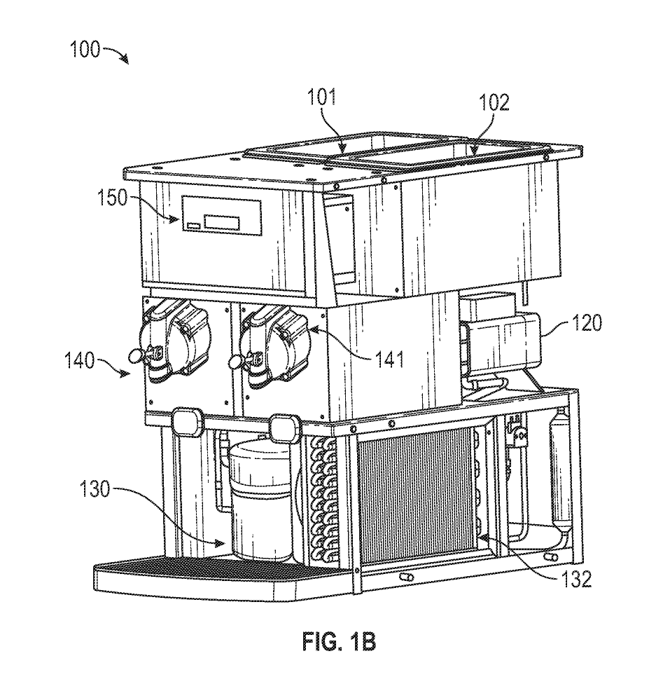

Certain details of the product storage system are generally provided in FIG. 2.

As reflected in FIG. 2, the exemplary product storage system includes hoppers 101 and 102, which, in the illustrated example, are in the form of stainless steel basins. Freezing barrels 105 and 106 are located below hoppers 101 and 102 allowing gravity to draw product from the hoppers 101 and 102 into freezing barrels 105 and 106. An opening in each hopper is provided to receive a single sensor 170 and 180. The sensors 170 and 180 may take various forms and can be capacitance sensors, infrared sensors, acoustic sensors, mechanical float sensors or any other suitable sensors. In the illustrated example, the sensors 170 and 180 are conductive sensors whose output varies between two states, one corresponding to a situation where the sensor is covered with product in the hopper, and the other where the level of product in the hopper has dropped to a level such that the sensor is no longer covered with the product to be dispensed. Other types of sensors, including, but not limited to resistive sensors may be used.

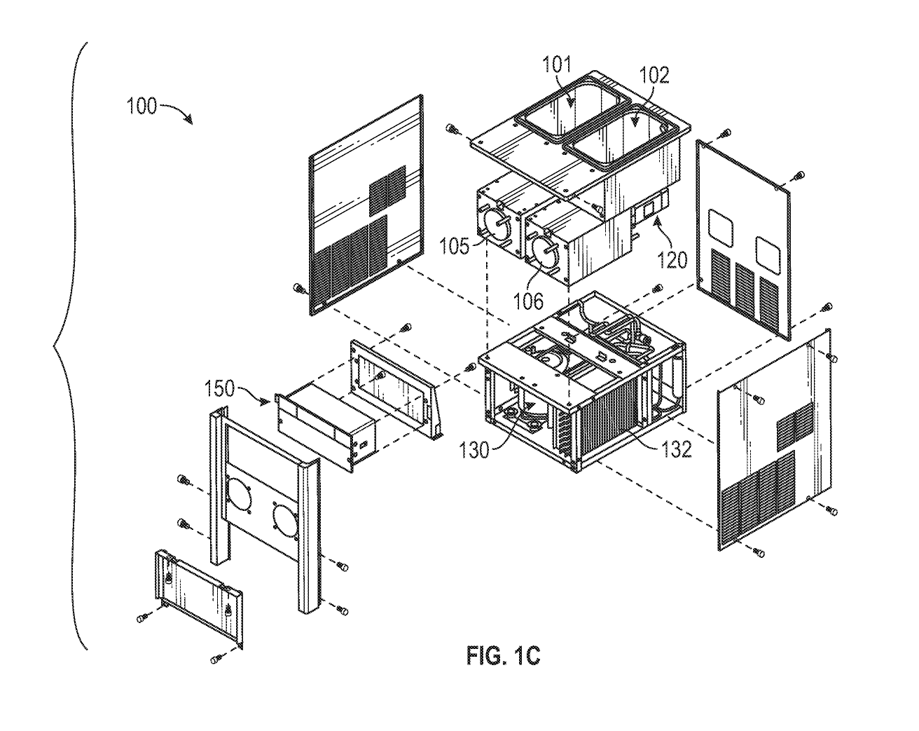

FIG. 3 illustrates an isometric cross-sectional view of exemplary frozen product dispenser showing a single hopper, a freezing and mixing barrel, a separation plate, and a mixing tube in accordance with certain teachings set forth herein. As reflected in FIG. 3, hopper 301 is formed to provide a drain 305 and a funnel-like structure that narrows towards the low point. An opening is provided at the low point of hopper 301 to facilitate the flow of the product. This design thus results in gravity feeding product placed into the hopper 301 to, and through the openings at the low points, thus allowing the gravity-fed filling of product from the hopper 301.

The cross-section of the freezing barrel 304 as seen in FIG. 3 shows a beater 308 and a separation plate 310. Connecting to and behind the separation plate 310 is a drive shaft 312 that is driven by a drive motor 321. The drive shaft 312 is inserted into the freezing barrel 304 through a seal 316, which prevents the product from seeping out. As can be seen, the mix tube 326 is set behind the separation plate 310 in the space above the drive shaft 312 within the freezing barrel 304. This allows product to be fed into the freezing barrel 304. The link between the beater 308 and the drive shaft 312 is a separation plate 310 that substantially fills the circumference of the freezing barrel 304 but leaves a gap for the flow of the product. This separation plate 310 presents a partition between the front and the back of the freezing barrel 304 and can control the rate of mixing between newly introduced product and the product ready for dispensing. An unregulated mixing of newly introduced product with the product ready for dispensing may result in a dispensed product that is not at the desired consistency or which does not have the appropriate amount of air mixed into it. Having this separation plate 310 in place can control the mixing allowing the newly introduced product to arrive at the proper consistency, temperature, expansion, and air mixture as it is being mixed with the product ready for dispensing in the forward portion of the freezing barrel 304.

Specifically for milk shakes and smoothies, the product to be dispensed typically is between 24° F. and 28° F. (−4.4° C. to −2.2° C.). This may be accomplished by the refrigerant around the freezing barrel 304. Newly introduced product will be at a higher temperature, such as it is maintained within the hopper 301. While this newly introduced product is being cooled to the optimal temperature, it is also being mixed with air to bring it to an optimal consistency, which expands the product.

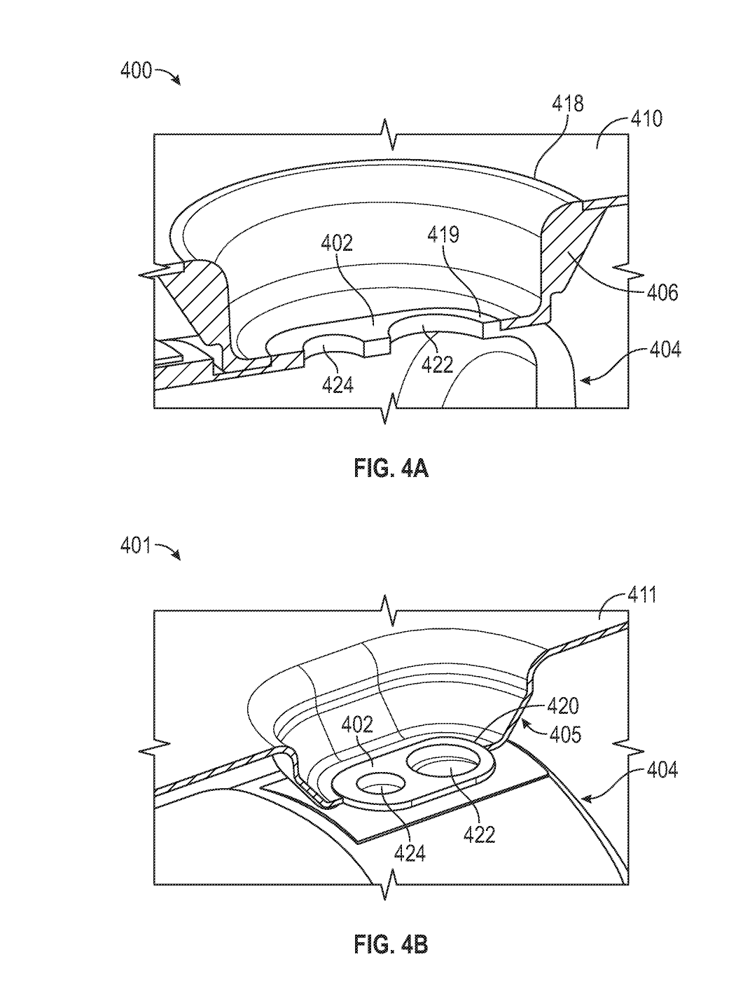

Turning now to FIG. 6, a view of separation plate 310 mounted on the drive shaft 312 within the freezing barrel 304 is seen. The length of the inside diameter 610 of the freezing barrel 304. The length of the diameter 612 of the separation plate 310. The distance 614 between the edge of the separation plate 310 and the inside circumference of the freezing barrel 304 has a length. Subtracting the area of the separation plate 310 from the area of the inside of the freezing tube 304 will yield the area of the gap between the edge of the separation plate 310 and the inside circumference of the freezing barrel 304.

Desirable results for freezing the newly introduced product while still dispensing properly frozen product has been achieved when the distance 614 between the edge of the separation plate 310 and the inside of the freezing barrel 304 is between 2% and 7% of the diameter 610 of the freezing barrel 304. This will result in the area 616 between the edge of the separation plate 310 and the inside circumference of the freezing barrel 304 being preferably no larger than 25% and preferably no smaller than 5% of the cross-section area of the freezing barrel 304. To state this another way, the diameter 612 of the separation plate 310 preferably is no smaller than 85% and preferably no larger than 97% of the diameter 610 of the freezing barrel 304.

Applicants have found that these parameters apply to separation plates for barrels of any size.

The mixing area within the gap between the edge of the separation plate 310 and the inside of the freezing barrel 304 is preferred because the greatest amount of cooling is provided from the outside of the freezing barrel 304. However, those skilled in the art can readily see that this exemplary embodiment of controlling the mixing of the frozen product with the unfrozen product may be obtained in other ways while still adhering to the spirit of the invention. In an alternative embodiment, the plate may be oval or of some other geometry while still retaining the relative dimensions of cross-sectional areas given. Similarly another envisioned embodiment may have holes in the plate to permit mixing in areas other than between the edge of the plate and the inside surface of the freezing barrel. In yet another envisioned embodiment, protuberances or fin-like projections may comprise the back side of the plate to provide some initial churning and aeration of the newly introduced product before it is mixed in a controlled manner with the frozen product ready for dispensing on the other side of the plate. In yet another envisioned embodiment, the edges of the plate may be irregular rather than smooth, or may be crimped or radially corrugated near the edge so that the rotation of the plate creates turbulence between the already frozen product and the newly introduced product proximate to the freezing barrel where the maximum refrigeration is located. Another envisioned embodiment may have scrapers or beaters attached to the separation plate 310 aligned in the direction behind the separation plate 310. These would be relatively smaller than the main scraper or beater 308 but would still agitate and mix the newly introduced product in the area behind the separation plate 310 but not interfere with the drive shaft 312 or the mix tube 326.

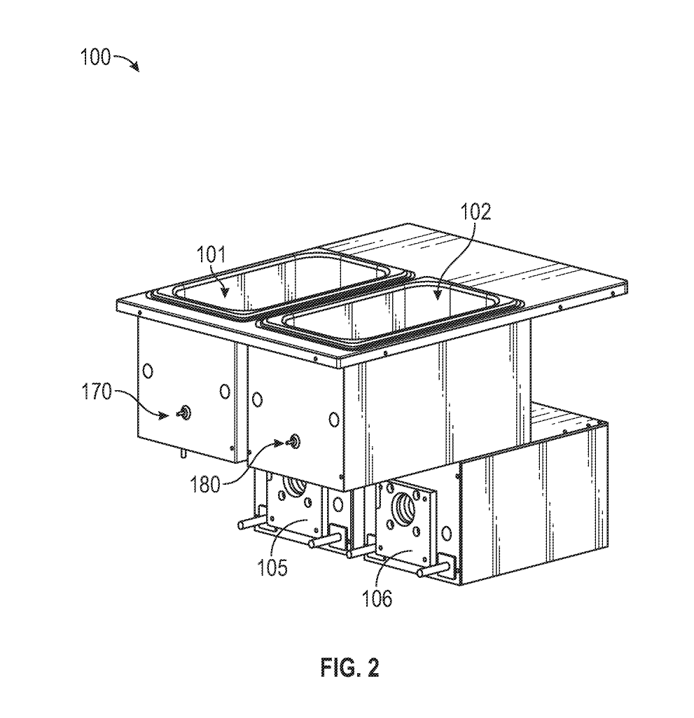

FIG. 4A illustrates an isometric cross-sectional view of the hopper and freezing barrel of an exemplary frozen product dispenser in accordance with certain teachings set forth herein. More specifically, FIG. 4A shows a closer view of the joining of the hopper 410 and the freezing barrel 404 shown in FIG. 3. This view shows a cross-section of the hopper 410 and its connection to the freezing barrel 404 through the use of a drain insert 406. The drain insert 406 and the hopper 410 must meet without a seam so that a mix tube assembly 232 may be installed so that no product from the hopper 410 may seep around the mix tube assembly 232 into the freezing barrel 404. The drain insert 406 is fitted into a hole in the bottom of the hopper 410. Correct alignment may be obtained through the use of making the hole in the hopper 410 and the upper area of drain insert 406 have matching shapes, such as an oval. Other shapes that provide for proper alignment may be envisioned by those skilled in the art without departing from the spirit of the inventions disclosed herein. The rear portion of the freezing barrel 404 may be machined so as to properly fit with the drain insert 406. In the illustrative figure, this shape is also oval so that the alignment may be achieved with minimal effort. This fitment requires two welds be made for assembly at seams 418 and 419. Traditional welding leaves residual material that must be ground and polished, so one goal of the inventions disclosed and taught herein is to secure these parts together without the use of traditional welding techniques that leave residue and require additional effort to grind and polish.

FIG. 4B illustrates an isometric cross-sectional view of the hopper and freezing barrel of an exemplary frozen product dispenser in accordance with certain teachings set forth herein. More specifically, FIG. 4B shows a view similar to that of FIG. 4A, but here the drain 405 is integrally formed in the manufacturing step of making the hopper 411. One such way of forming this is through stamping the material to form this drain. In this exemplary illustration the drain 405 has an oval cutout. Similar to FIG. 4A, a boss 402 has been machined from the freezing barrel 404 with a corresponding oval. Holes 422 and 424 are drilled through the boss. When fitted together, the hopper 411 and the freezing barrel 404 will be positioned and aligned properly. It is preferred to have a tight fit between the edges of the drain opening and the edges of the boss. A process known as Tungsten Inert Gas (TIG) welding is suitable for mating the two parts as it does not add metal from a consumable electrode, as is done in many other welding processes, but rather welds together the two pieces with a non-consumable Tungsten electrode engulfed in an inert gas. This weld 420 results in a weldment that is seamless and provides a smooth surface in the drain 405 in the hopper 411 which will not require polishing or grinding away excess material so that a mix tube may be accurately and completely fitted within the drain 405 of the hopper 411. The weld will use material from the machined boss 402 to permanently affix the hopper 411.

Securing the hoppers 410 and 411 and the freezing barrel 404 together in the ways described herein has several advantages. First, having a clean weld is essential to properly forming any dispensing machine. Eliminating the addition of filler products from traditional welding instruments provides for cleaner surfaces and may be more advantageous in having the dispenser adhere to quality, safety, and sanitary regulations. Commensurate with this, having a weld that requires little to no grinding or polishing saves time and effort needed to produce a quality dispenser. Another advantage is that there is more contact surface between the hopper 410 411 and the freezing barrel 404 because of grinding away the metal on the freezing barrel 404 to produce the machined boss 402. When this material is cut away, it leaves a flat surface on the freezing barrel 404, which matches the flat lower surface of the drain 405 or the drain insert 406. Similarly, the upper surface of drain insert 406 offers a large flat surface capable of providing good support for the hoppers 410 and 411. More surface area in each of these cases reduces strain between the parts and will reduce the chances of the seam splitting from fatigue or fracture.

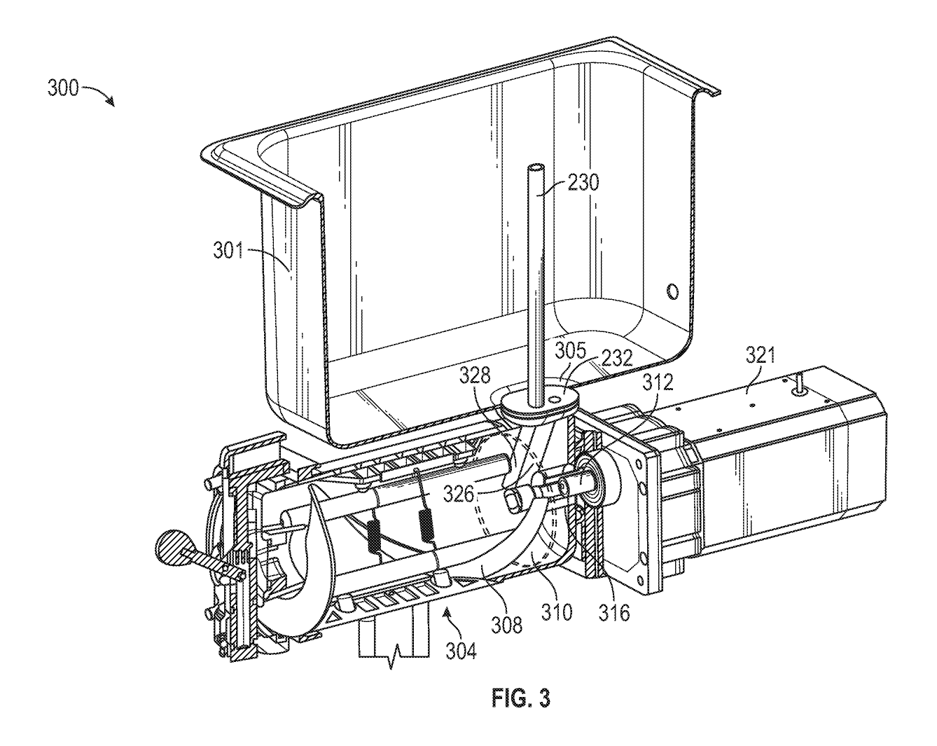

FIGS. 5A and 5B show that weld 420 may be performed in different manners on the freezing barrel 404. FIG. 5A shows that a portion of the freezing barrel 404 may have a flat surface at the top of freezing barrel 404 upon which the drain 405, or drain insert 406 of the hopper 410 or 411 may be welded. Similarly, FIG. 5B shows that the drain 405 of the hopper 410 or 411 may be welded directly to the freezing barrel 404 without creating a flat surface. It will be obvious to anyone skilled in the art that both of these as well as other implementations are available for creating a seamless weld through the use of this process.

Referring back to FIG. 3, a view of the mix tube assembly 232 may be seen. The mix tube assembly 232 sits in the cavity between the hopper 301 and the freezing barrel 304 in the drain 305 to control the unregulated flow of product in the hopper 401 from being introduced into the freezing barrel 404.

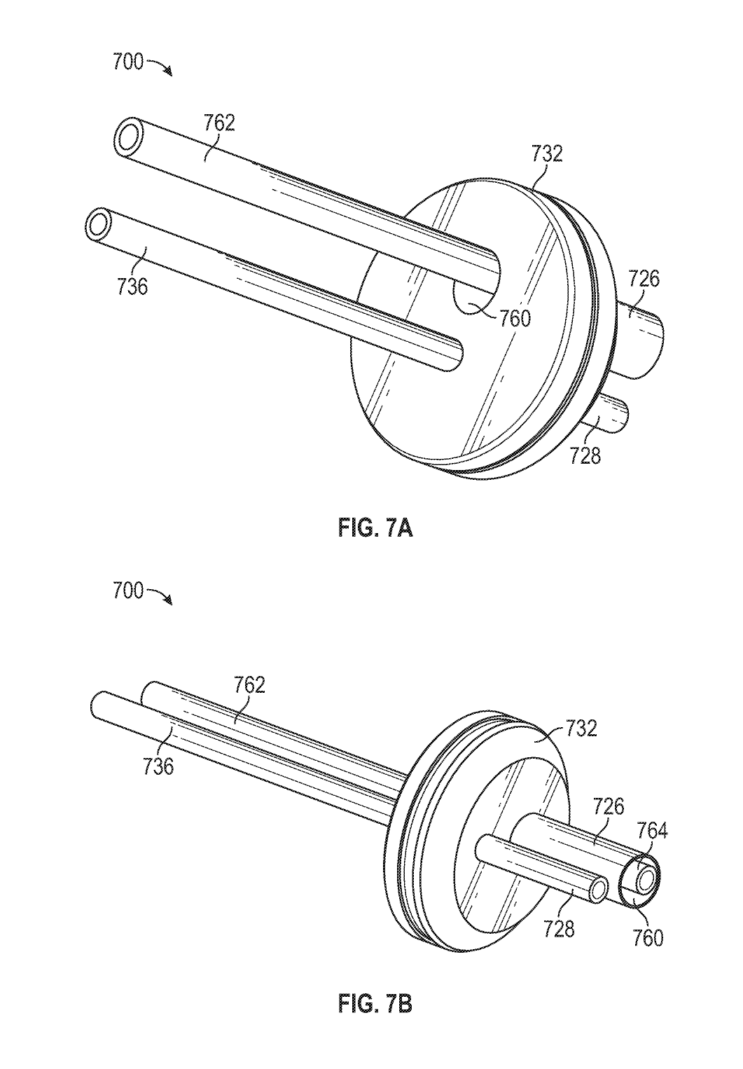

FIG. 8 illustrates an exploded view of an exemplary mix tube and adjustable overrun control of an exemplary frozen product dispenser in accordance with certain teachings set forth herein. Mix tube assembly 802 is an alternative embodiment of mix tube assembly 232 shown in FIG. 3. Mix tube assembly 802 may be described as having a mix tube base 832. The base contains holes through it in fluid communication with two tubes below, the lower air tube 828 and the product tube 826, and in fluid communication with one tube above, the upper air tube 836. The product annulus 834 is in direct fluid communication with hopper 301. The top of the upper air tube 836 typically must remain above the level of the product in the hopper 301. Since the product in the hopper 301 is typically opaque, an operator may not be able see down to the top surface of the mix tube base 832.

As the product is drained from the hopper 301 into the freezing barrel 304, air is also drawn in through the upper air tube 836 and mixed with the product. This initial mixing is done behind the separation plate 310 and is then slowly mixed with the frozen product in front of the separation plate 310 (as is shown, for example, in FIG. 3).

The mix tube base 832 is preferably dimensioned to fit within the drain 305 of the hopper 301 and is preferably of sufficient mass to not be disrupted or moved during the normal process of filling the hopper 301 with product. This may be accomplished by having the mix tube base 832 be sufficiently heavy to sit flush within the drain 305 of the hopper 301 so that a seal is formed, or this may be accomplished by having one or more O-rings encompass the mix tube base 832 to effect a seal when it is inserted into the drain 305 cavity of the hopper 301. Additional methods for retaining the mix tube base 832 in the drain 305 may be envisioned without departing from the spirit of the inventions described herein. From this, one of ordinary skill in the art should appreciate that having a smooth weldment as described previously and depicted in FIG. 4 may be beneficial to effect a seal through the use of the mix tube base 832 between the hopper 301 and the freezing barrel 304.

The lower air tube 828 and the product tube 826 are angled from the plane of the mix tube base 832. This may be so that the depth of these tubes is well within the freezing barrel 304 when inserted but not touching the drive shaft 312 as may be seen in FIG. 3. Having a mix tube base 832 and a cooperating drain 305 of the hopper 301 of an oval or elliptic shape will promote the proper insertion of the mix tube assembly 830 into the drain 305 of the hopper 301, but having a circular mix tube base 832 with cooperating drain 305 will not preclude proper insertion as an operator will be able to rotate the mix tube assembly 830 during insertion to ensure that no part of the mix tube assembly 830 touches the drive shaft 312.

In operation, when frozen product is dispensed from the dispensing device 300, a similar amount of product is drawn into the freezing barrel 304 due to the resulting pressure difference. The level of the product in the freezing barrel 304 will not exceed a level far above the lower end of the lower air tube 828. In one exemplary embodiment, the product annulus hole 834 has been designed to match the inside diameter of the product tube 826 and does not regulate the flow of any additional product into the freezing barrel so that as product is dispensed, an appropriate amount is introduced. In some situations, this exemplary embodiment has the potential to introduce product into the freezing barrel quickly if a large amount of frozen product is dispensed in a short time. The result could be a quantity of product in the freezing barrel that is not aerated to a certain level nor to a certain consistency. The adjustable overrun mix tube control assembly 801 shown in FIG. 8 may provide additional control over the introduction of product into the freezing barrel 304 and thus additional control over the aeration level and consistency.

The adjustable overrun mix tube control assembly 801 comprises an indicator handle 850 and a plate 852. The plate 852 is designed to fit on the top of the mix tube base 832 and effectively cover the product annulus hole 834. The plate 852 may have a one or more holes through it and any of them may be placed over the product annulus hole 834 by rotating the plate 852 to the desired position. In FIG. 8, the plate is shown with three holes: a large hole 854, a medium hole 856, and a small hole 858. Without deviating from the spirit and intent of this invention, other numbers and sizes of holes may be in the plate 852. Having other shapes rather than circles may be utilized in embodiments envisioned by Applicants, such as slots that are tapered. In yet another envisioned embodiment, the plate of the overrun mix tube assembly is not required to have a flat upper surface. In one envisioned embodiment, structures of tapered conics, straight cylinders, or other structures may be utilized.

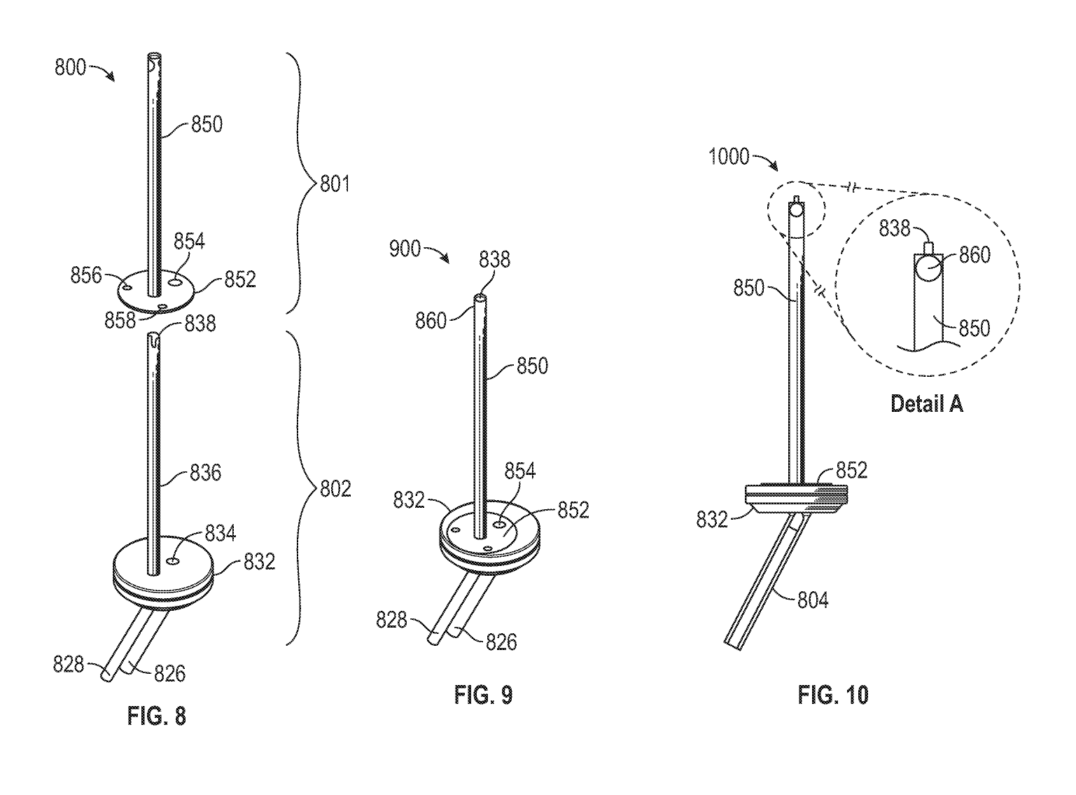

In this exemplary embodiment depicted in FIG. 9, the large hole 854 in the plate 852 is substantially the same size as the inside diameter of the product tube 826. When these holes are aligned, the amount of product that may be introduced into the freezing barrel would be the same with or without the adjustable overrun mix tube control assembly 801. As described previously, when demand of the product is high, there is a possibility of introducing product into the freezing barrel at non-preferred rate. If an operator can foresee this eventuality, he or she may rotate the plate 852 by turning the indicator handle 850 so that a smaller hole lies atop the product annulus hole 834. This will slow the introduction of product into the freezing barrel 304 so that the mixing of newly introduced product with the frozen product already in the freezing barrel 304 will maintain a preferable consistency and quality.

Referring back to FIG. 8, a tab 838 may be seen at the top of the upper air tube 836. This tab is positioned on a side of the upper air tube 836 relative to the position of the mix tube base 832 and the general direction of the lower tubes. As can be seen in Detail A of FIG. 10, the direction of the angle offsetting the lower tubes may be ascertained from the position of the tab 838. Positioning this tab at a correct alignment within the hopper 301 will ensure that the lower tubes are positioned away from the drive shaft 312 when the mix tube assembly 830 is inserted. This tab may also be used to determine which hole of the adjustable overrun mix tube control assembly 801 is positioned above the product annulus hole 834. As was noted earlier, the product may be opaque so an operator may need an indicator of which hole in the plate 852 is atop the product annulus hole 834. As seen in FIG. 9, the product annulus hole 834 will be below the large hole 854 in the plate 852 when the indicator handle 850 is turned so that indicator 860 is visible to the operator and substantially aligned in the same orientation as the tab 838. The other indicators for other holes may be similarly marked on the indicator handle 850 so that the rotation of the indicator handle 850 to align those indicators with the tab 838 will place a different hole above the product annulus hole 834.

In yet another of many possible embodiments, notches in the plate 852 may be made to fit with projections on the surface of the mix tube base 832 to ensure proper alignment and to resist movement of the plate when the unit is jarred or jostled. Similarly, the weight of the adjustable overrun mix tube control assembly 800 pressing against the surface of the mix tube base 832 has been found to be adequate to control the rate of addition of product without concern that product may seep under the plate 852 and into the product annulus hole 834. However, other envisioned embodiments may include sealing the plate 852 to the surface of the mix tube base 832 to prevent any seepage.

In the embodiment depicted in FIG. 10, a tube is used as the indicator handle 850 as it is convenient to manufacture with the entire adjustable overrun mix tube control assembly 801 and is easy for an operator to grasp and rotate to a desired position. Other embodiments may be envisioned that do not use a tube for the indicator handle 850. Similarly, other indicators of the relative alignment of the adjustable overrun mix tube control assembly 801 may be envisioned rather than the indicator 860 depicted in this exemplary embodiment.

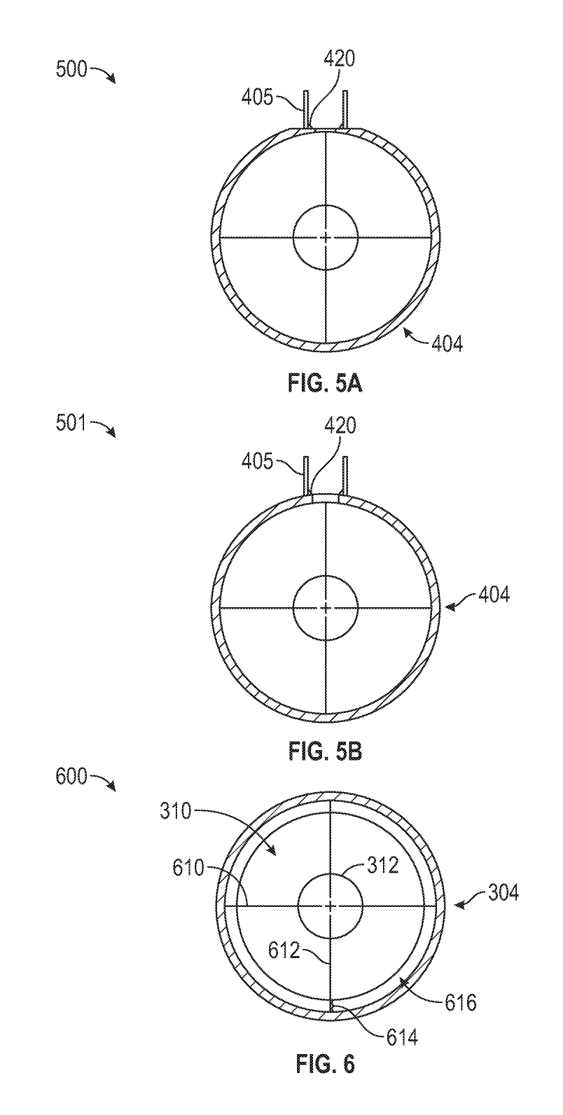

FIGS. 7A and 7B illustrate an exemplary mix tube of an exemplary frozen product dispenser in accordance with certain teachings set forth herein. Initially, it should be noted that in some frozen beverage systems, when product flows from the hopper into the freezing barrel it may forcibly displace the air. In some cases, this has resulted in bubbles of air moving upwards through the fill tube and bursting at the surface of the product in the hopper. This unregulated flow of product may leave a non-desirable amount of air (too much or too little air) in the freezing barrel resulting in a product that does not have a desirable consistency and quality. The traditional remedy for this problem has been to dispense and discard the undesirable product until a steady state has been achieved with appropriate proportions of air and product being introduced into the freezing barrel 304 providing a consistent product of high quality. This waste of product may be undesirable for many reasons.

The dual fill tube assembly 700 depicted in FIGS. 7A and 7B provides a way for product and air to be mixed while filling the freezing barrel for the first time, and also provides a means for allowing the air already in the freezing barrel to be expelled without carrying any entrained product. The dual fill tube assembly 700 comprises a mix tube base 732 similar to those previously disclosed along with an upper 736 and lower air tube 728 cooperating with a hole through the mix tube base 732. The dual fill tube assembly differs from the other exemplary embodiments disclosed herein in that it has a product annulus 760 through the mix tube base 732 allowing product to enter the freezing barrel through the product tube 726, but also containing within it a secondary air tube comprising an upper secondary air tube 762 and a lower secondary air tube 764 residing within the product tube 726 as seen in FIG. 7B.

When filling the device for the first time, the product will be poured into the hopper and will flow through the product annulus 760 into the freezing barrel. The effect of the effluent of the product at the bottom of the product tube 726 in conjunction with the lower secondary air tube 764 will be to draw the air down the tube through a suction similar to a venturi jet pump. This suction will provide an initial mixing of air with the product at the termination of the product annulus 760 and the lower secondary air tube 764. While the air and product mixture is filling the freezing barrel, the air already contained in the freezing barrel is being displaced and ejected through the lower 728 and upper air tube 736. Filling will continue until the level of the mixed product reaches a point of equilibrium wherein there will still be some air in the freezing barrel that will be mixed with the introduced product. The placement of the bottom of the lower air tube 728 relative to the bottom of the product tube 726 will dictate the amount of air remaining in the freezing barrel after the initial introduction of the product such that a relatively longer lower air tube 728 will leave more air in the freezing barrel than a relatively shorter lower air tube 728. These relative lengths may be varied depending upon the product to produce a product with a desirable amount of air in it.

While FIGS. 7A and 7B depict one embodiment of this invention, other embodiments may be envisioned without departing from the spirit of this invention. For example, another envisioned embodiment may have the lower secondary air tube and the lower fill tube angled so that they do not interfere with the drive shaft. As was noted previously, the fill tube base may be round or of another geometry to appropriately be inserted and retained in the receiving low point of the hopper. In this case, the upper tubes may have indicator markings on them to show how the assembly is to be oriented when fitted into the low point of the hopper. Others sufficiently skilled in the art would be able to envision other embodiments of this invention as well.

Utilizing a dual fill tube assembly as depicted in FIGS. 7A and 7B does not preclude the use of an adjustable overrun control assembly as depicted in FIGS. 8-9. One skilled in the art may envision an embodiment of an adjustable overrun control assembly where the indicator handle is a tube surrounding the upper air tube and the plate has notches to fit along a side of the upper secondary air tube thus covering the annulus. When the adjustable overrun control assembly is in this position, an appropriate hole through the plate would control the rate of flow into the annulus. Other embodiments may be envisioned as well.

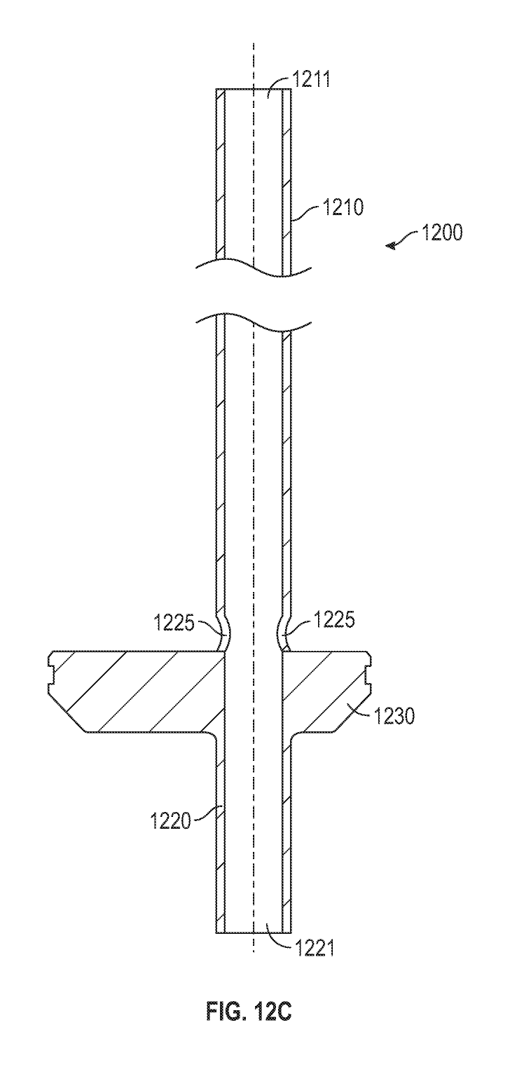

An alternative mix tube assembly embodiment is depicted in FIGS. 12A, 12B, and 12C. In this exemplary embodiment, the mix tube base 1230 has an upper mix tube 1210 and a lower mix tube 1220, which are in continuous fluid communication through the mix tube base 1230. The upper outlet 1211 of the upper mix tube 1210 will be above the level of the ingredients in the hopper 301, and the lower outlet 1221 will descend into the freezing barrel 304. There is an additional hole 1225 through the upper mix tube 1210 just at or slightly above the upper surface of the mix tube base 1230. In this embodiment, when product is dispensed from the freezing barrel 304, the ingredients will be drawn into the mix tube assembly 1200 through the hole 1225 in the upper mix tube 1210. Air will also be drawn in through the upper outlet 1211. Both of these will be somewhat mixed together as they descend into the freezing barrel 304 through the lower mix tube 1210. Other embodiments may be envisioned for this mix tube assembly without departing from the spirit of the inventions disclosed and taught herein.

In some situations, controlling the rate of air entering the freezing barrel may be desirable in producing quality product. In one situation that may be envisioned, a very viscous mix of ingredients may be in the hopper. Without any control, air would be drawn quicker into the freezing barrel as frozen product is dispensed. While the viscous mix of ingredients will eventually be drawn into the freezing barrel, the air that has been more rapidly introduced will be beaten with product currently in the freezing barrel, which may result in a product that is not preferentially desired. On the other hand, slowing the rate of air entering the freezing barrel when product is dispensed will create a pressure differential that can be used to more quickly pull in the viscous mix of ingredients before too much air is allowed to interact with the product.

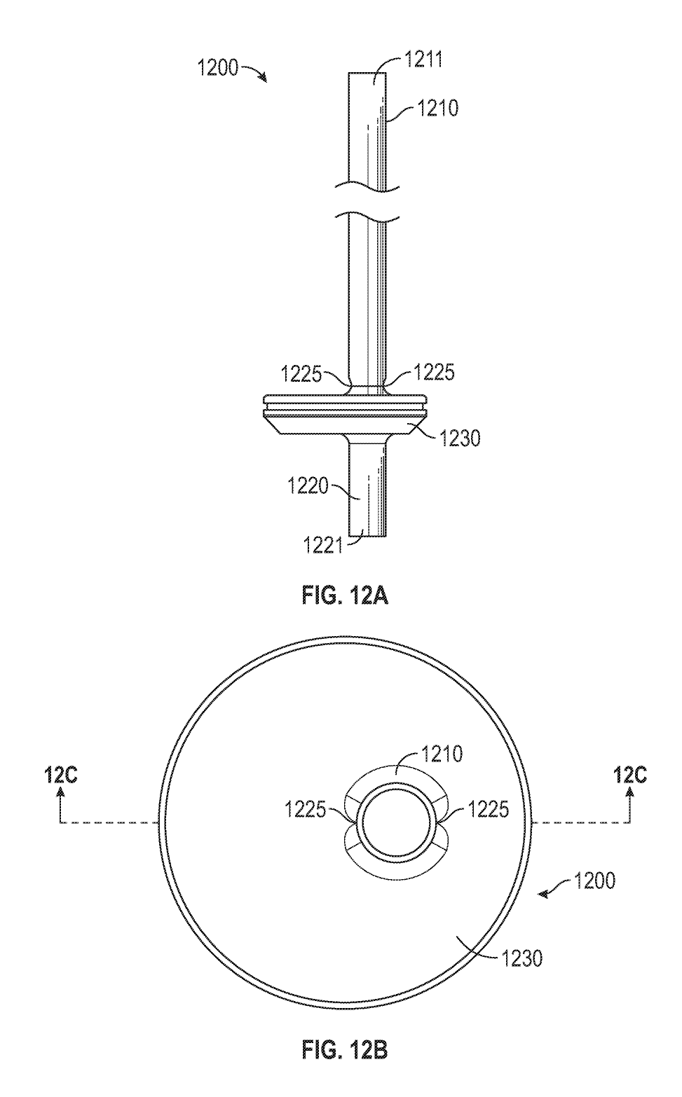

Turning now to FIGS. 11A and 11B, an exemplary air control cap 1101 for controlling the rate of air allowed into the freezing barrel 304 is shown in accordance with certain teachings set forth herein. FIG. 11A shows a top view 1100 of an air control cap 1101 with notches 1110 and 1120 and indicators 1111-1114. These notches 1110 and 1120 may be aligned to regulate the flow of air into the freezing barrel 304 when mounted on an upper air tube 230. The side view of an exemplary air control cap 1130 also shows the notches 1120 extend for some distance down the sides of the air control cap 1101. There is a cutout 1140 going from the outside of the air control cap 1101 to the interior. The hole 1150 is sized so that a moderately tight fit will be made when the air cap 1101 is removably secured to the top of an upper air tube 230. The upper air tube 230 will have a slot (not shown) corresponding to the cutout 1140 so that when the cutout 1140 in the air control cap 1101 and the slot are aligned, there will be a free flow of air into the upper air tube 230. However, when the air control cap 1101 is turned relative to the upper air tube 230, the flow of air will be restricted. An operator can determine the position of the cutout 1140 of the air control cap 1101 relative to the slot in the upper air tube (not shown) through the use of the indicators 1111-1114. In one embodiment, aligning the “C” indicator 1111 with a marking on the upper air tube 230 will close or seal the upper air tube 230 by placing the cutout 1140 in a position so that no portion of it overlaps the slot in the upper air tube 230. By rotating the air control cap 1101 to align the notch 1120 next to indicator “1” 1112, some portion of the cutout 1140 will overlap the slot in the upper air tube 230. Continuing to rotate the air control cap 1101 will align indicator “3” 1114 with a marking on the upper air tube 230, which will make the cutout 1140 of the air control cap fully align with the slot in the upper air tube 230.

It should be noted that the air control cap 1101 and the adjustable overrun mix tube control assembly 801 may be used with the mix tube assembly embodiment depicted in FIGS. 12A-C. The air control cap 1101 may be positioned on the upper air tube 1210 to control the rate of air being let into the upper outlet 1211 as previously described. Similarly, an embodiment of an adjustable overrun mix tube control assembly may be envisioned that has slots that overlap and regulate the amount of ingredients that may enter the holes 1225 on the upper mix tube 1210 of the mix tube assembly 1200. Similar to what has been described above, the rate of ingredients could be controlled by aligning an appropriately sized slot to overlap the hole 1225 in the upper mix tube 1210. Those skilled in the relevant arts may envision other embodiments.

Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A frozen food dispensing machine, comprising:
a product chamber that defines a bottom having a drain opening passing therethrough, the drain opening being defined by a portion of the bottom having a thickness;
a freezing barrel positioned substantially below the product chamber comprising a machined surface that defines a leveled portion in contact with a portion of the product chamber proximate to the drain opening, and a boss raised above the leveled surface, wherein the height of the boss is substantially equal to the thickness of the product chamber that defines the drain opening; and
a weldment having no seam that provides a smooth surface between the product chamber and the freezing chamber.

2. The food dispensing machine of claim 1, wherein the product chamber is integrally formed and the drain opening is defined by a portion of the product chamber extending to a depth below the bottom of the product chamber.

3. The food dispensing machine of claim 1, further comprising at least one opening in the boss.

4. The food dispensing machine of claim 1, wherein the outer diameter of the boss matches the outer diameter of the drain opening.

5. The food dispensing machine of claim 4, where the matching diameters have at least one axis of symmetry.

6. The food dispensing machine of claim 5, where the matching shapes are oval.

7. The food dispensing machine of claim 1, where the weld is made with Tungsten Inert Gas welding.

8. A frozen food dispensing machine, comprising:
a product chamber defining a bottom opening;
a drain insert positioned within the bottom opening, the drain insert having an upper surface and a lower surface, the upper surface of the drain insert being configured to mate with the bottom opening of the product barrel, the drain insert further defining a beveled portion extending from the upper surface to the lower surface;
wherein the lower surface of the drain insert is substantially flat, has a thickness, and defines a drain opening extending therethrough;
a freezing chamber positioned substantially below the product barrel and comprising a surface that has been machined to define:
(i) a substantially flat portion arranged to be positioned below, and to support the substantially flat lower surface of the drain insert and
(ii) a raised boss extending from within the flat portion, wherein the raised boss has a shape configured to extend into the drain opening and wherein the height of the boss is substantially equal to the thickness of the lower surface of the drain insert; and
a weldment having no seam that provides a smooth surface between the lower surface of the drain insert and the freezing chamber.

9. The food dispensing machine of claim 8, further comprising at least one hole in the boss.

10. The food dispensing machine of claim 9, wherein at least two of the at least one hole have different diameters.

11. The food dispensing machine of claim 8, where the shape of the boss matches the shape of the drain.

12. The food dispensing machine of claim 11, where the matching shapes are oval.

13. The food dispensing machine of claim 8, where the weld is made with Tungsten Inert Gas welding.

14. A frozen food dispensing machine, comprising:
a product chamber comprising a bottom wherein at least a portion of the bottom is flat, an opening for a drain within the flat area on the bottom, and where the flat area on the bottom has a thickness;
a freezing barrel positioned substantially below the product chamber and comprising a machined surface that has been leveled to contact a portion of the product chamber proximate to the opening for the drain in the product chamber, a boss comprising a portion of the machined surface left raised above the leveled surface and having the same thickness as the product chamber, and wherein the outer edges of the boss are configured to abut the inner edges of the drain opening; and
a weldment having no seam that provides a smooth surface between the product chamber and the freezing chamber.

15. The food dispensing machine of claim 14, further comprising an area around the drain opening extended to a depth below the bottom of the product chamber.

16. The food dispensing machine of claim 14, further comprising at least one hole in the boss.

17. The food dispensing machine of claim 14, further comprising the boss and the drain opening having matching outline shapes.

18. The food dispensing machine of claim 17, where the matching shapes have at least one axis of symmetry.

19. The food dispensing machine of claim 18, where the matching shapes are oval.

20. The food dispensing machine of claim 14, where the weld is made with Tungsten Inert Gas welding.
